(19) United States
(12) Patent Application Publication
(10) Pub. No.: US 2013/0182184 A1
(43) Pub. Date: Jul. 18, 2013

(54) VIDEO BACKGROUND INPAINTING

(71) Applicants: Turgay Senlet, Piscataway, NJ (US); Shan He, Princeton, NJ (US)

(72) Inventors: Turgay Senlet, Piscataway, NJ (US); Shan He, Princeton, NJ (US)

(21) Appl. No.: 13/350,281

(22) Filed: Jan. 13, 2012

(51) Int. Cl. H04N 5/272

(52) U.S. Cl. CPC H04N 5/272
USPC 348/586

(57) ABSTRACT

Several implementations provide inpainting solutions, and particular solutions provide spatial and temporal continuity. One particular implementation accesses first and second pictures that each include a representation of a background. A background value is determined for a pixel in an occluded area of the background in the first picture based on a source region in the first picture. A source region in the second picture is accessed that is related to the source region in the first picture. A background value is determined for a pixel in an occluded area of the background in the second picture using an algorithm that is based on the source region in the second picture. Another particular implementation displays a picture showing an occluded background region. Input is received that selects a fill portion and a source portion. An algorithm fills the fill portion based on the source portion, and display the resulting picture.

### TECHNICAL FIELD

Implementations are described that relate to video content. Various particular implementations relate to estimating background values for foreground content.

### BACKGROUND

When a foreground object is moved, or removed, a background region is revealed. These newly revealed regions are often filled, and it is desirable to fill these regions with meaningful and visually plausible content.

### SUMMARY

According to a general aspect, a first pictures is accessed that includes a first representation of a background. The first representation of the background has an occluded area in the first picture. A background value is determined for one or more pixels in the occluded area in the first picture based on a source region in the first picture. A second picture is accessed that includes a second representation of the background. The second representation is different from the first representation and has an occluded area in the second picture. A source region is determined in the second picture that is related to the source region in the first picture. A background value is determined for one or more pixels in the occluded area in the second picture using an algorithm that is based on the source region in the second picture.

According to another general aspect, a display of a picture is provided that indicates an occluded background region. An input is received that selects a fill portion of the occluded background region to be filled. An input is received that selects a source portion of the picture to be used as candidate background source material for filling the selected fill portion. An algorithm is applied to fill the selected fill portion based on the selected source portion, resulting in a resulting picture that has the fill portion filled. The resulting picture is displayed.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a block/flow diagram depicting an implementation of a video editing system, apparatus, and process.

FIG. 2 is a block/flow diagram depicting another implementation of a video editing system, apparatus, and process.

FIG. 3 is a pictorial representation of an implementation showing video pictures for editing, as well as a process for editing video content.

FIG. 4 is a pictorial representation of an implementation showing video masks for use in editing, as well as a process for editing video content.

FIG. 5 is a pictorial representation of an implementation showing video mosaics for use in editing, as well as a process for editing video content.

FIG. 6 is a pictorial representation of another implementation showing video mosaics for use in editing, as well as a process for editing video content.

FIG. 7 is a block/flow diagram depicting an implementation of a process, apparatus, and system for editing video content.

FIG. 8 is a pictorial representation of an implementation of a user interface, as well as a process, apparatus, and system, for editing video content.

FIG. 9 is a block/flow diagram depicting an implementation of a system, apparatus, and process for processing video content.

FIG. 10 is a block/flow diagram depicting an implementation of another process, apparatus, and system for editing video content.

FIG. 11 is a block/flow diagram depicting an implementation of a process, apparatus, and system for communications.

FIG. 12 is a block/flow diagram depicting another implementation of a process, apparatus, and system for communications.

### DETAILED DESCRIPTION

At least one implementation addresses the problem of hole-filling incurred during a two-dimensional (“2D”) to three-dimensional (“3D”) conversion process. In particular, the implementation focuses on background hole filling. In the implementation, particular foreground objects are removed from a scene and the revealed background regions are filled-in using mosaics and video inpainting techniques. The revealed regions are filled with meaningful and visually plausible content. Additionally, spatial and temporal consistency of the frames is maintained.

During a typical 2D to 3D conversion, foreground objects are usually selected and are isolated from the background for further editing. Examples of such further editing includes 3D object modeling, and/or horizontal shifting. The objects are then re-rendered to generate one or more new views. For example, an object may be laterally (horizontally) shifted to reflect the position the object would occupy from a different viewing angle. After such editing and re-rendering, the content in the background which was originally occluded by the foreground objects may be revealed in the new view(s). These newly revealed regions are then typically filled with content. At least one implementation described in this application fills the regions with meaningful and visually plausible content that is continuous both spatially and temporally.

The same technology can be applied to fill the holes in general object removal in video editing, for example, removing objects, people, logos, shadows, and/or similar stationary or non-stationary elements from a video sequence. In a broader sense, the background can include any object whose occluded area is to be filled.

At least one implementation described in this application has the advantage of both temporal and spatial continuity of the filled regions. Additionally, at least one implementation iteratively fills in the missing information (content) on different background layers.

In various implementations, the following methodology is applied: (i) build one or more mosaic images from all the frames in a group of frames in the video sequence, (ii) decide on the pixel values in a given mosaic based on one or more selection criteria, (iii) do image inpainting on the mosaic image(s), and (iv) transform the mosaic image(s) back to views of the frames. The resulting frames can be used directly or they can be used to fill in the empty regions of the original frames.

Various implementations use multiple mosaic images, rather than a single mosaic image. The use of multiple mosaic images has, in various implementations, one or more advantages. One such advantage is that the pixel values of a given mosaic image are not necessarily the best for filling the corresponding points in all the frames that make up the given mosaic. This may occur, for example, because the camera motion is not totally planar, there is motion blur in some of the frames, and lighting and/or overall intensity of the frames are not exactly the same.

Various implementations also provide a certain amount of automation. This can be a valuable advantage because hole-filling can be a time-consuming process when performed by hand. Additionally, various implementations provide non-global optimization which can be valuable because global optimization can be both time-consuming and processor-intensive. At least one implementation provides a complete pipeline to build a sequence of meaningful background frames in which the foreground objects have been removed from a given video sequence.

At least one implementation builds on the framework proposed in one or more of the following two references which are each hereby incorporated by reference in their entirety for all purposes: (i) Kedar A. Patwardhan, Guillermo Sapiro, and Marcelo Bertalmio, “Video Inpainting Under Constrained Camera Motion,” IEEE Transactions on Image Processing, vol. 16, no. 2, 2007, (ii) A. Criminisi, P. Perez, and K. Toyama, “Region Filling and Object Removal by Exemplar-Based Image Inpainting,” IEEE Transactions on Image Processing, vol. 13, no. 9, 2004, and (iii) R. I. Hartley, and A. Zisserman, “Multiple View Geometry in Computer Vision,” Cambridge University Press, March 2004.

At least one implementation in this application builds a mosaic for each of the N frames in the input sequence. In one implementation, the mosaic images are built as described, for a single mosaic, in the “Video Inpainting Under Constrained Camera Motion” reference. Further, particular implementations apply, for a given frame, the homographic transformation calculated between that frame and the reference frame, as described in the “Multiple View Geometry in Computer Vision” reference. After the transformations, for each mosaic, we obtain a sequence of N frames aligned to each other. The information missing from one frame can frequently be filled in with the content from another frame that has the content revealed.

In order to attempt to reduce the visual artifacts in each mosaic, particular implementations use the available content from the nearest neighbor frame to fill in the current frame. For example, we consider one scene consisting of 16 frames. If the rectangle area defined by the two corners of (0,0) and (10,10) is to be filled in frame 5, and frame 7 to frame 10 all have the content, then we choose the corresponding content in frame 7 to paste into frame 5 because frame 7 is the nearest neighbor (among frames 7 to 10) of frame 5. Here the nearest neighbor frame has a broad meaning in that it does not necessarily mean the temporally nearest. Rather, we refer to the nearest neighbor as the content-wise (or content-based) nearest neighbor (or nearest frame).

For example, in various implementations, the video sequence is alternating between two scenes: frames 1-5 are for scene 1; frames 6-10 are for scene 2; and frames 11-15 are for scene 1; etc. In such implementations, if, for example, frame 5 is significantly different from frames 1-4, then the nearest frame for frame 5 may be frame 11 rather than frame 6. In such a case, for frame 5, frame 11 is the content-wise nearest frame and frame 6 is the temporally nearest frame.

Frame similarity for the whole frame is used, in various implementations, to determine whether the scene has changed or not. The frame similarity is measured, for example, using any of a number of comparison techniques, such as, for example, mean-square-error. Various implementations apply a threshold to the frame similarity to determine if the scene has changed.

In various implementations that produce multiple mosaics, inpainting is performed on each mosaic. One such implementation applies image inpainting on each of the mosaic images separately. This generally produces good quality for each of the inpainted mosaic images in terms of spatial continuity within the mosaic image. Other such implementations, however, link the inpainting process among the sequence of mosaics to attempt to reduce the computational complexity, and to attempt to increase temporal continuity in the inpainted mosaic sequence. In various such implementations, temporal continuity is increased in the new rendered sequence that is based on the output of the multiple mosaics whose inpainting processes are linked together.

One such linking implementation begins with any mosaic i in the sequence of N mosaics, and applies an inpainting method. One such inpainting method is based on that described in the “Region Filling and Object Removal by Exemplar-Based Image Inpainting” reference. For each mosaic, the area to be filled is divided into various blocks referred to as “filling blocks”. A filling block may contain only pixels that have no data, or may also contain pixels that have data. A source block is identified as the basis for filling each individual filling block. For each filling block in mosaic i, after the source block is selected, the co-located filling blocks in the other N-1 mosaics are analyzed to determine respective source blocks. Note that a block (in one of the other N-1 mosaics) that is co-located with a filling block from mosaic i may, or may not, need to be filled.

A co-located block refers to a block in another frame, or mosaic, etc., that has the same location. Typically, this means that the block and its co-located block have the same (x, y) coordinates. For frames that do not have high motion between them, then co-located blocks will typically have the same, or similar, content. Even for high motion, given a block in a first frame, it often occurs that the co-located block in a second frame is not displaced far from the block in the second frame that has the same, or similar, content as the block in the first frame.

A corresponding block refers to a block in another frame, or mosaic, etc., that has common content. For example, if the same light bulb (to use a small object) occurs at different locations in two frames, there will be a block (perhaps multiple blocks) in each frame that contains the light bulb (the content). These blocks, however, will not typically be in the same (x, y) locations in their respective frames. These blocks are not, therefore, co-located blocks, but they are corresponding blocks. Even for high motion, given a block in a first frame, it often occurs that the co-located block in a second frame is not displaced far from the corresponding block in the second frame.

A search is performed for each of the other N-1 co-located filling blocks. For each of the N-1 mosaics, the search for a source block is performed within a neighborhood of a block that is co-located with the source block of frame i. Even if motion occurs between the different mosaics, if similar motion exists for the filling block and the source block, then the co-located source block is often a good match for the co-located filling block. And if the co-located source block is not a good match, then it often occurs that a good match is located close to (and within the neighborhood of) the co-located source block.

After all the co-located filling blocks are filled, the implementation proceeds to the next filling block in mosaic i. In this way, the search range for the filling blocks in the remaining N-1 mosaics is limited to blocks that are in a neighborhood of the co-located source block. In various implementations, the neighborhood has an extent that is, for example, an s-by-s neighborhood, where s is an integer. Limiting the search provides, in typical implementations, a significant reduction in complexity.

Additionally, because the co-located filling blocks in all of the N mosaics are filled at the same time in this implementation, the filling order is the same for all the mosaics in the sequence. The consistent filling order typically helps to provide temporal consistency for the filling region.

Note that temporal consistency is, in certain implementations, provided or increased by two factors. A first factor is the use of the co-located source blocks as the basis of the neighborhood search for each mosaic. This typically results in each mosaic filling co-located filling blocks based on content (source content) from similar areas of the mosaics. If the search for source content were not restricted to, or at least begun with, the co-located source block, it is possible that the selected source content would be drawn from completely different regions of the mosaic for different mosaics. Such completely different regions would often have slight variations in the source blocks, resulting in temporal discontinuity.

A second factor is the use of a consistent filling order across the N mosaics. Previously filled filling blocks can often be part of the search space associated with a subsequent filling block. Therefore, the previously filled filling block may be selected as the source block for the subsequent filling block. By using a consistent filling order across all mosaics, the search spaces for any given set of co-located filling blocks are provided with a certain amount of consistency and commonality. This typically increases the temporal consistency of the resulting inpainted mosaics.

Certain implementations search the entire frame, or even the entire mosaic, to find the best match for each of the filling blocks. One such implementation uses the algorithm described in the “Region Filling and Object Removal by Exemplar-Based Image Inpainting” reference. This can be computationally expensive, particularly for video sequences with high resolution, such as HD content, and 2K and 4K digital cinema content. The computational complexity may be worthwhile, but other implementations attempt to reduce the computational complexity.

Certain implementations attempt to reduce the computational complexity using the inventors' observation that the source block for a given filling block typically occurs in a local neighborhood of the filling block. Thus, to further reduce the complexity, several implementations limit the search range of the inpainting in mosaic i to a neighborhood of the filling block. For example, in particular implementations, a rectangular neighborhood with size S-by-S is used. The search range S is a parameter set by the user and, in general, S is much larger than s. That is, the neighborhood used for determining the source block for the initial filling block is much larger than the neighborhood for determining source blocks for co-located filling blocks. Other implementations also, or alternatively, use the above inventor observation by dividing the mosaic, or the images, into several smaller images to perform the inpainting.

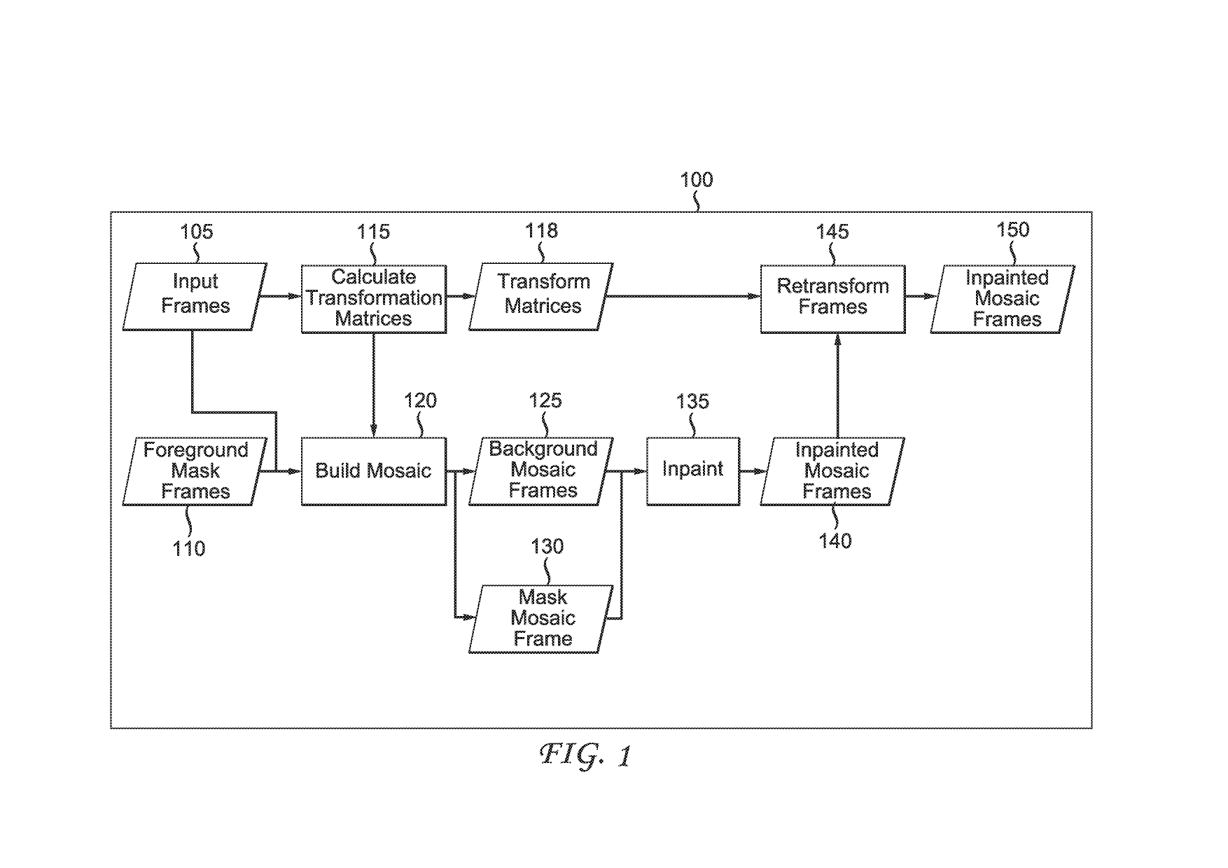

Referring to FIG. 1, a system 100 is provided as an implementation. The inputs for this implementation are a video sequence of frames and a mask sequence indicating the filling region in each frame. The output for this implementation is a video sequence with the foreground objects removed and the filling regions filled. As an overview, the system 100 creates a separate mosaic for each frame, but all mosaics are from the same reference coordinate system.

1. The system 100 includes a frame input block 105. The frame input block 105 receives the input video frames. Alternate implementations allow a user to select the input frames. One frame is selected as the reference frame for the sequence of input video frames. Various implementations select the reference frame by, for example, allowing a user to select the reference frame, or automatically selecting a frame as the reference frame. Various implementations automatically select as the reference frame, for example, the first frame, the middle frame, the first I-picture, or the most detailed frame. The most detailed frame is defined, for various implementations, as the frame having the smallest area to fill.

2. The system 100 includes a foreground mask input block 110 that receives a foreground mask frame for each input video frame. Various implementations determine the foreground masks by hand, that is, by a person. Other implementations calculate the foreground masks.

3. The system 100 includes a transformation calculation block 115 receiving the input frames from the frame input block 105. The transformation calculation block 115 estimates the transformations between the input video frames and the reference frame. This is done, for example, by finding noticeable features on frames and matching them to their versions on the reference frame. Particular implementations use features identified by a scale-invariant feature transform (“SIFT”) for this calculation. Certain implementations that use SIFT features also remove foreground SIFT features by accessing the foreground mask frames from the foreground mask input block 110. One specific implementation uses Random Sample Consensus (“RANSAC”) to pick, for each frame that is to be transformed, the best four features between that frame and the reference frame. The techniques described in the reference “Video Inpainting Under Constrained Camera Motion” are also applied in various implementations.

The transformation calculation block 115 produces a set of transformation matrices for transforming the input video frames to the reference frame. The system 100 includes a transformation matrices output block 118 that provides the transformation matrices.

4. The system 100 includes a mosaic building block 120 that receives (i) the input video frames from the frame input block 105, (ii) the transformation matrices from the transformation calculation block 115, and (iii) the foreground mask frames from the foreground mask input block 110. The mosaic building block 120 builds a set of mosaics for the input video frame sequence. Typically, the mosaics are built by transforming each of the non-reference input frames to the reference frame view. The transformations will bring the frames into alignment with each other.

A separate mosaic is typically built for each frame. Each mosaic is based on the same reference, and is built from the same set of frames (including the reference frame and the transformed frames). However, each mosaic is typically constructed differently.

In one implementation, each mosaic begins with a different initial frame (transformed or reference), and adds the remaining frames (transformed or reference) in an order reflecting a distance to the initial frame. The distance is, in different implementations, based on content, on interframe distance, on a combination of content and interframe distance, and/or on a weighted combination of content and interframe distance, for example. Content-wise distance ranks the frames in terms of how close the frames match the content of the initial frame (a histogram is used in various implementations). Thus, in this implementation, each separate mosaic starts with a different initial frame, and builds the separate mosaics by adding content from the other frames in an order that depends on the initial frame. In various implementations, the constructed mosaics have background holes, and inpainting is performed (as described elsewhere) based on the constructed mosaics.

An alternative implementation starts each mosaic by identifying a base frame (transformed or reference). This alternative implementation then inserts into the mosaic the frame (transformed or reference) that is furthest from the base frame. This alternative implementation then overlays into the mosaic the background content from each of the other frames (transformed or reference) in an order that gets progressively closer to the base frame. This alternative implementation then finally overlays into the mosaic the content from the base frame. The term “overlay” refers to overwriting an existing pixel value with a new pixel value. Such an “overlay” is performed when the new pixel value represents background content, rather than, for example, a masked location for a foreground object.

The mosaic building block 120 also transforms each mask frame to the reference frame view using the calculated transformation matrices. Typical implementations also build a mosaic of the transformed mask frames and the reference mask frame.

Various implementations build the mosaics (video and mask) in different ways. Certain implementations use a nearest neighbor algorithm that operates as follows: (i) determine an order of the frames indicating the distance to the reference frame, and (ii) copy the transformed video frames to the video mosaic starting with the farthest frame, and proceeding in order to the closest frame, and ending with the reference frame. This ordered approach will overwrite various locations in the video mosaic with data from closer transformed frames. The copy operations are masked, using the transformed frame masks, so that only pixels containing information are copied. Thus, the final video mosaic will have the data at each pixel location that is closest to the reference frame. For example, if two frames have data for a specific location that is occluded in the reference frame, the data from the closest frame will be used in the final video mosaic.

The distance between frames is determined in various ways. Particular implementations use distance that is, for example, the inter-frame distance or a content-based distance. As discussed elsewhere, content-based distance is, for example, a rank ordering of frames in terms of the degree of content similarity, as measured, for example, by a histogram analysis.

The mask mosaic is built, in particular implementations that use a mask mosaic, in the same way as the video mosaic. The mask mosaic includes, in simple implementations, a single bit at each pixel location. The bit at each location indicates whether that pixel is occluded in the video mosaic and is to be filled. Typical implementations of the system 100 produce only a single mask mosaic.

The mosaic building block 120 produces, therefore, a set of background video mosaics, one for each frame, and a mask mosaic. The system 100 includes a background video mosaic output block 125 that provides the background video mosaics, and includes a mask mosaic output block 130 that provides the mask mosaic.

5. The system 100 includes an inpainting block 135. The inpainting block 135 receives the background video mosaics from the background video mosaic output block 125. The inpainting block 135 also receives the mask mosaic from the mask mosaic output block 130. The inpainting block 135 inpaints the masked portions of the background video mosaics using the mask mosaic to identify the masked portions. Other implementations use the background video mosaics themselves to identify the masked portions. In such implementations, the masked portions are given a specific value or a flag bit to indicate that they are masked.

In typical implementations, the inpainting begins with one frame/mosaic, usually the reference frame/mosaic, and propagates to the other frames in the background video mosaics. Implementations use, for example, one or more of the methods described in this application. Certain implementations perform the inpainting automatically, and other implementations allow an operator to provide input to indicate, for example, the filling region and/or the source region.

The inpainting block 135 produces a set of inpainted background video mosaics (referred to also as mosaic frames). The system 100 includes an inpainted mosaic output block 140 that provides the inpainted background video mosaics.

6. The system 100 includes a retransformation block 145 that receives the inpainted background video mosaics from the inpainted mosaic output block 140. The retransformation block 145 also receives the transformation matrices from the transformation matrices output block 118. The retransformation block 145 performs retransformations on the inpainted background video mosaics, also referred to as inverse transformations. Typically, the retransformation block 145 also determines retransformation matrices to be used in performing the retransformation. The retransformation matrices are, typically, the inverse of the transformation matrices.

The retransformation block 145 creates an output video sequence of inpainted background frames, from the retransformation of the mosaics. The retransformation block 145 creates a single output video sequence. Each mosaic corresponds to one frame (referred to as a base frame or main frame). That is, for frame i, there is a corresponding mosaic i. The retransformation block 145 re-transforms mosaic i to get only frame i in its original view/coordinates and does not generate other frames. The collection of the re-transformed base frames i (i=1, . . . , N) is the output video sequence.

Another implementation, however, retransforms all frames in each mosaic, producing a set of video sequences (one sequence for each retransformed mosaic). The implementation then selects the base frame from each sequence, and combines the base frames into a final video sequence.

The output video sequence is the original input video frame sequence with the foreground objects removed, and the occluded portions filled. The occluded portions are filled either with data copied from corresponding locations in other frames in the sequence that did not occlude that portion, or with inpainted data.

The system 100 includes an inpainted background frames output block 150 that provides the inpainted background frame output sequence.

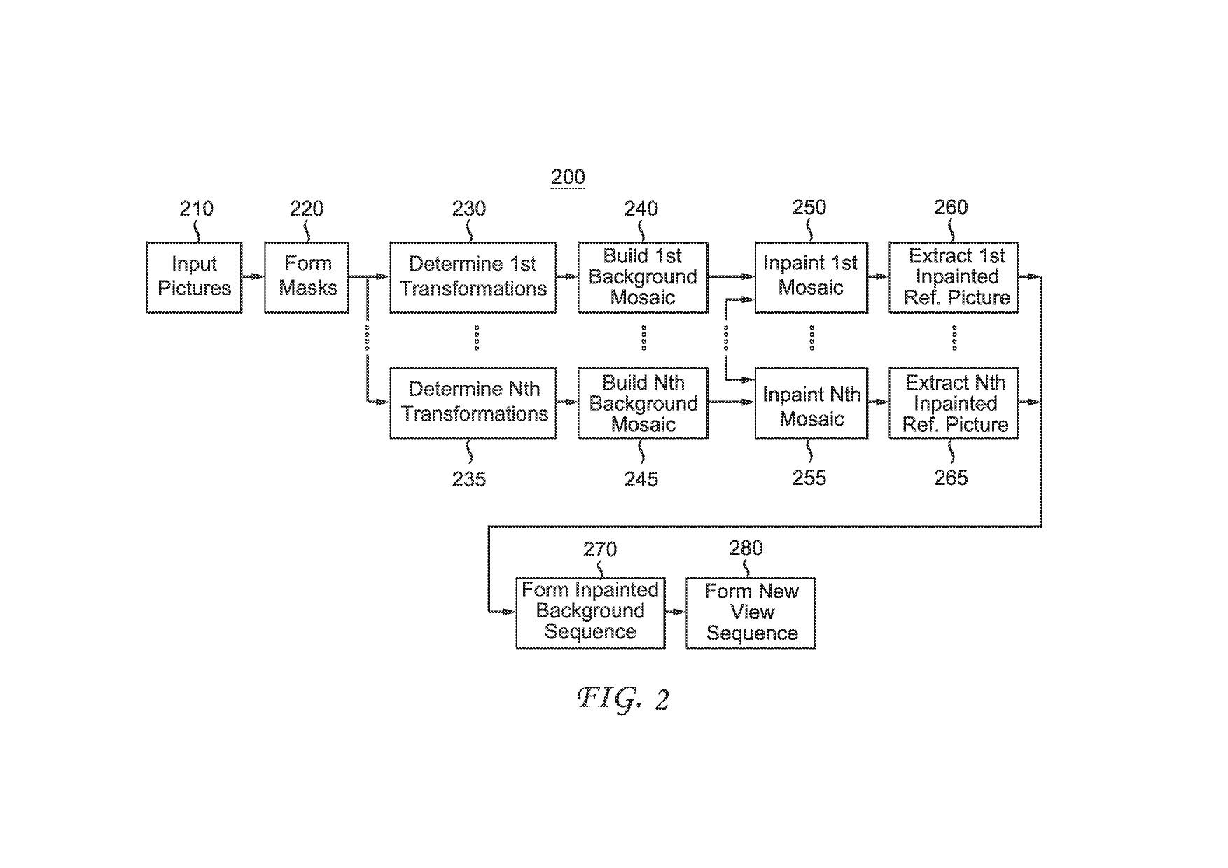

Referring to FIG. 2, there is provided a system 200. The system 200 includes an input pictures block 210 that operates, in various implementations, as described for the frame input block 105. The system 200 further includes a mask formation block 220 that operates, in various implementations, as described for the foreground mask input block 110.

The mask formation block 220 is shown as receiving input from the input pictures block 210. Such a connection allows particular implementations of the system 200 to create the foreground/background masks based on the input pictures.

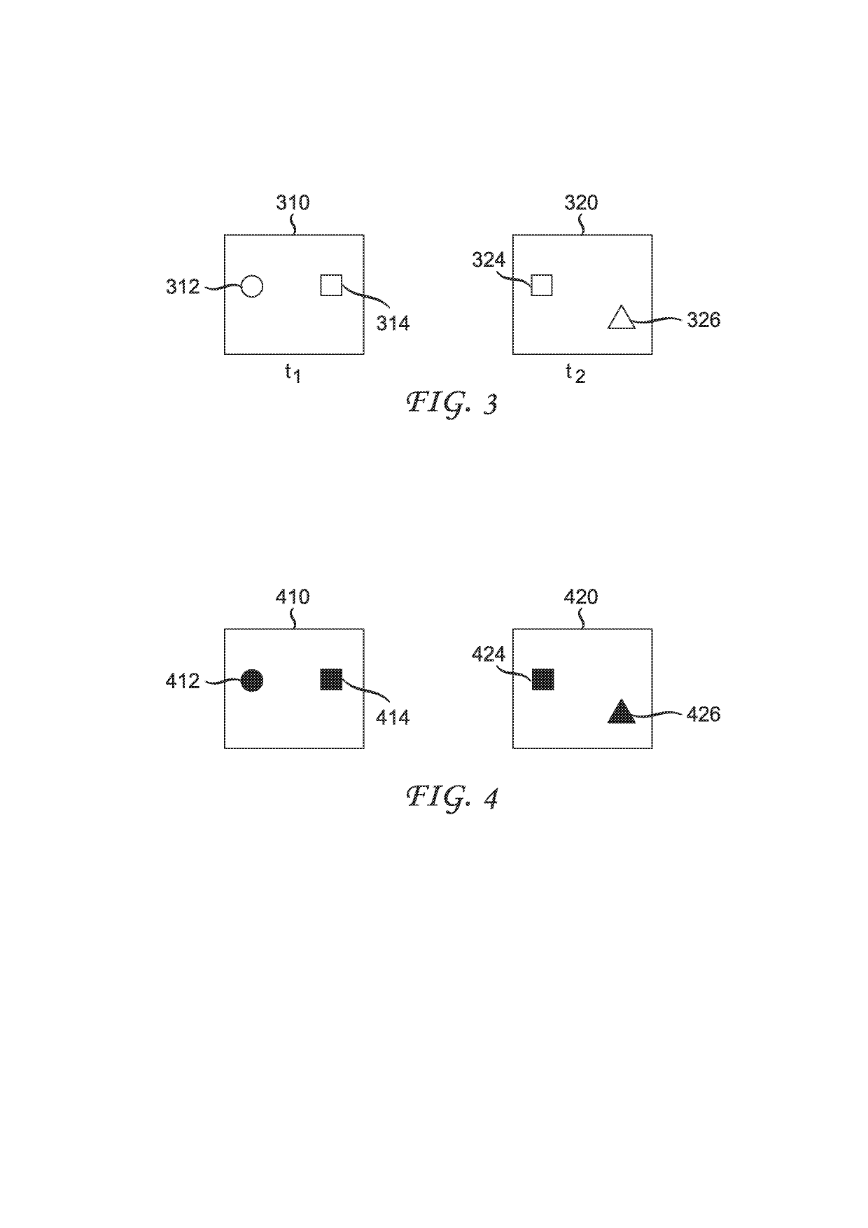

Referring to FIG. 3, an example of an input sequence is provided. FIG. 3 includes a first picture 310 that includes a foreground circle 312 and a foreground square 314. FIG. 3 includes a second picture 320 that includes a foreground square 324 and a foreground triangle 326. The foreground square 324 is the same object as the foreground square 314, but is shifted due to the motion between the first and second picture 310, 320. The first picture 310 is from a time t1, and the second picture 320 is from a time t2 that is later than the time t1.

Referring to FIG. 4, an example of a mask sequence is provided. FIG. 4 includes a first mask 410 that is a mask of the first picture 310. FIG. 4 also includes a second mask 420 that is a mask of the second picture 320. The first mask 410 includes a masked portion 412 corresponding to the foreground circle 312, and a masked portion 414 corresponding to the foreground square 314. The second mask 420 includes a masked portion 424 corresponding to the foreground square 324, and a masked portion 426 corresponding to the foreground triangle 326.

Referring again to FIG. 2, the system 200 includes a series of transformation determining blocks receiving input from the mask formation block 220. The transformation determining blocks thus receive as input both the masks and the input pictures. FIG. 2 illustrates, in particular, a first transformation determining block 230 and an Nth transformation determining block 235, where N is typically the number of frames. The transformation determining blocks each determine a transformation for a different mosaic. The implementation of FIG. 2 creates a separate mosaic for each picture in the input picture sequence. The first transformation determining block 230 determines a set of transformation matrices for transforming the input pictures to the reference view of, for example, the first picture in the sequence. The Nth transformation determining block 235 determines a set of transformation matrices for transforming the input pictures to the reference view of, for example, the last (Nth) picture in the sequence.

In particular implementations, the mosaic for a given input picture uses that given input picture as the reference picture for the mosaic. However, variations of the system 200 select the reference picture for each mosaic in different manners, such as, for example, the manners described elsewhere in this application.

The system 200 includes a series of background mosaic building blocks. The implementation of FIG. 2 illustrates, in particular, a first background mosaic building block 240 and an Nth background mosaic building block 245. The first background mosaic building block 240 creates a mosaic using the first set of transformation matrices, provided by the first transformation determining block 230. The Nth background mosaic building block 245 creates a mosaic using the Nth set of transformation matrices, provided by the Nth transformation determining block 235.

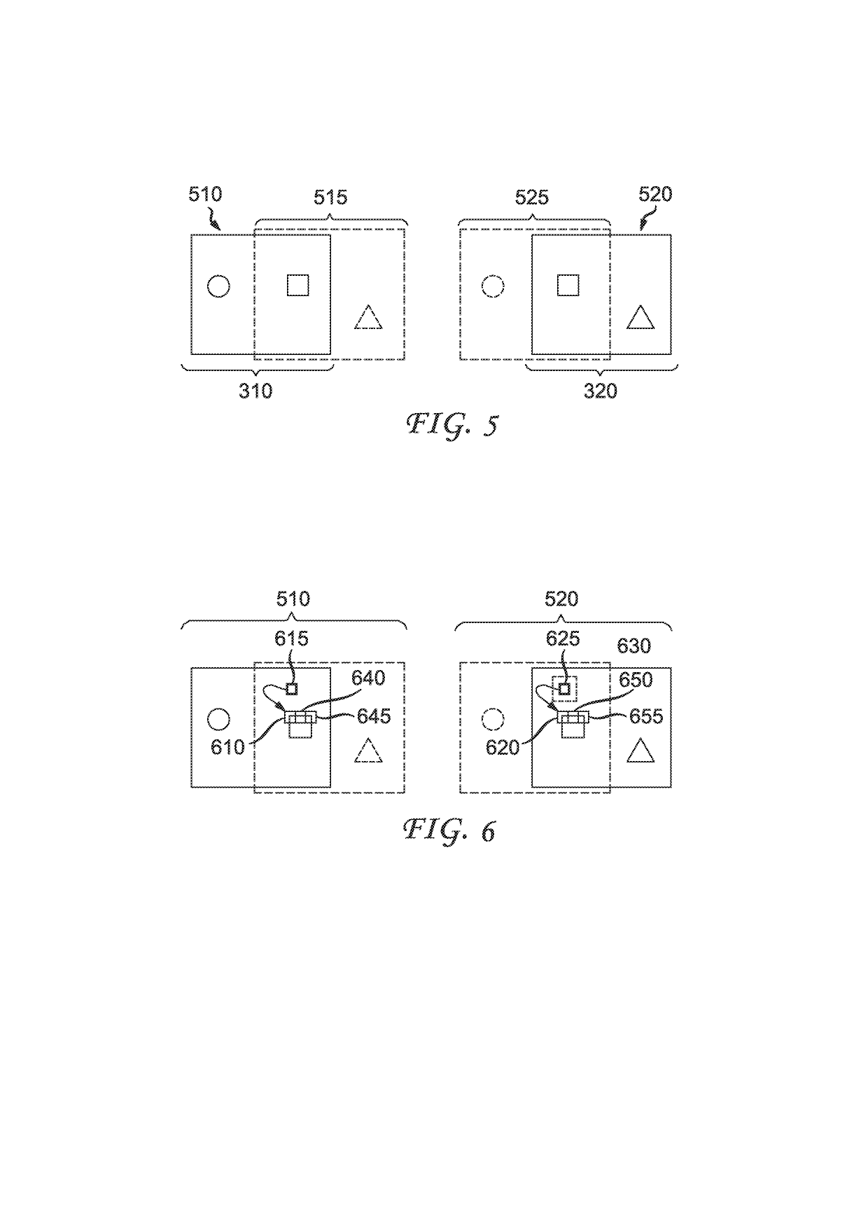

Referring to FIG. 5, an example of a set of mosaics is provided. FIG. 5 includes a first mosaic 510 that includes the first picture 310 and portions of a transformation 515 of the second picture 320. FIG. 5 also includes a second mosaic 520 that includes the second picture 320 and portions of a transformation 525 of the first picture 310.

Referring again to FIG. 2, the system 200 includes a series of inpainting blocks. The implementation of FIG. 2 illustrates, in particular, a first mosaic inpainting block 250, and an Nth mosaic inpainting block 255. The first mosaic inpainting block 250 receives the first background mosaic from the first background mosaic building block 240, and fills the occluded regions that remain in the first mosaic. The Nth mosaic inpainting block 255 receives the Nth background mosaic from the Nth background mosaic building block 245, and fills the occluded regions that remain in the Nth mosaic.

The mosaic inpainting blocks 250, 255 operate on a block basis, and look for a best matching block to fill a given filling area in the remaining occluded portions of the mosaic. Various implementations of the mosaic inpainting blocks 250, 255 are based on the inpainting described in the reference “Region Filling and Object Removal by Exemplar-Based Image Inpainting”. In at least one implementation, a filling block is selected that includes some pixels that are to be filled and some pixels that have data (possibly data from a previous filling operation). Then a source block (also referred to as a patch) is selected that has the lowest squared error among the data pixels of the filling block. This process is repeated for all filling blocks until the inpainting is complete.

FIG. 2 also shows connections between the various mosaic inpainting blocks. This provides a mechanism for communication between the mosaic inpainting blocks. In various implementations, this communication is used to attempt to provide temporal continuity. The temporal continuity is provided in various implementations by using source blocks from similar locations in neighbor pictures.

Referring to FIG. 6, an example is illustrated that is configured to provide temporal continuity. FIG. 6 includes the first mosaic 510 and the second mosaic 520. The first mosaic 510 includes a filling area 610 that includes some pixels with no data and some pixels that have data. A source area 615 is determined that provides a good match with the pixels in the filling area 610 that have data. The source area 615 is, in various implementations, copied entirely into the filling area 610. However, in other implementations the pixels in the filling area 610 that already have data retain their data, and are not overwritten by pixels from the source area 615.

The temporal continuity is provided, or at least encouraged, by using the location of the source area 615 to guide the inpainting of the second mosaic 520. The second mosaic 520 has a filling area 620 that corresponds to the filling area 610. The second mosaic 520 also has a source area 625 that corresponds to the source area 615. To fill the filling area 620, the second mosaic 620 is searched in a neighborhood 630 around the source area 625 for the best match with the filling area 620. Thus, the corresponding filling areas 610 and 620 are filled with source areas that are drawn from similar corresponding locations in the respective mosaics 510 and 520. The approach described with respect to FIG. 6 is applied, in various implementations to one or more of the system 100 and the system 200.

Referring again to FIG. 2 and to FIG. 1, various implementations of the inpainting process fill each mosaic in the same order to provide, or at least encourage, additional temporal continuity. For example, referring again to FIG. 6, the first mosaic 510 also includes a second filling area 640 and a third filling area 645. The inpainting process fills the filling areas 610, 640, 645 in that order. This allows, for example, the inpainted result from the filling area 610 to be used as a source for filling the filling area 640. To provide a similar search space for the subsequent mosaics, and thereby to provide or encourage additional temporal continuity, the same filling order is used in subsequent mosaics. Thus, for example, in the second mosaic 520, the inpainting process fills the filling area 620, then fills a filling area 650 that corresponds to the filling area 640, and then fills the filling area 655 that corresponds to the filling area 645. Note that various implementations apply one or both of the co-located filling approach described above with respect to FIG. 6, and the common fill order approach described in this paragraph, in an effort to provide temporal continuity.

Note that at least one implementation determines the filling order based on characteristics of the filling area. Certain implementations, in particular, determine the filling order based on a process described in the reference “Region Filling and Object Removal by Exemplar-Based Image Inpainting”. For example, some of these implementations determine a filling order based on, for example, the strength of edges adjacent to holes in a filling area, and on the confidence of pixel values surrounding the holes in the filling area.

Referring again to FIG. 2, the system 200 includes a series of reference picture extraction blocks receiving input mosaics from respective mosaic inpainting blocks. FIG. 2 illustrates, in particular, a first reference picture extraction block 260 and an Nth reference picture extraction block 265. The reference picture extraction blocks each extract the inpainted background reference picture from the respective input mosaic. In various implementations, the first reference picture extraction block 260 extracts the first inpainted background picture from the first inpainted mosaic, and the Nth reference picture extraction block 265 extracts the Nth inpainted background picture from the Nth inpainted mosaic.

Given that the reference picture extraction blocks extract only the inpainted background reference picture, certain implementations do not inpaint the entire mosaic. Rather, such implementations inpaint only the portion of the mosaic corresponding to the reference picture. However, other implementations do inpaint the entire mosaics to attempt to provide spatial continuity. By inpainting the entire mosaic, any given inpainted picture will have source areas selected using a common process.

For example, referring again to FIG. 6, if the first mosaic 510 is only inpainted for a portion corresponding to the first picture 310, then the second mosaic 520 will have a hybrid inpainting process applied to a portion corresponding to the second picture 320. That is, the filling areas associated with the foreground square 324 (or the masked portion 424) will be filled using source areas indicated from the inpainting of the first mosaic 510. However, filling areas associated with the foreground triangle 326 (or the masked portion 426) will be filled using source areas indicated from a separate inpainting process applied only to the second mosaic 520.

Referring again to FIG. 2, the system 200 includes an inpainted background sequence formation block 270 that forms the inpainted background sequence using input from each of the reference picture extraction blocks 260, 265. In various implementations, the inpainted background sequence formation block 270 simply concatenates the extracted inpainted background reference pictures to form a new video sequence. Notably, the system 200 does not perform any reverse transformation.

The system 200 further includes a new view sequence formation block 280 that receives as input the background video sequence from the inpainted background sequence formation block 270. The new view sequence formation block 280 also receives as input some information (not shown in FIG. 2) indicating the position of the new view. Additionally, typical implementations receive both the foreground objects and the foreground masks for each frame. Indeed, in particular implementations, each object in a frame has a separate mask. These implementations move the foreground objects to new locations to create a new view. Such implementations allow different disparity values to be applied to different objects in a straightforward manner.

In various implementations, a foreground (or object) mask contains an object number (a consistent integer number for each object throughout the scene) and the corresponding foreground object content is obtained from the original image. Note that various implementations identify the foreground object region of the new view frame, and do not perform an transformation, mosaicing, or inpainting for such regions.

The position of an object in a new view is obtained, for example, in certain implementations, from a table of disparity values for the various foreground objects. The new view sequence formation block 280 is provided the disparity table, and inserts the foreground objects at shifted locations (compared to the original input pictures), as provided by the disparity values in the table. The new view sequence and the original video sequence provide a pair of sequences that, in certain implementations, are a stereoscopic picture-pair sequence that can be used for 3D applications.

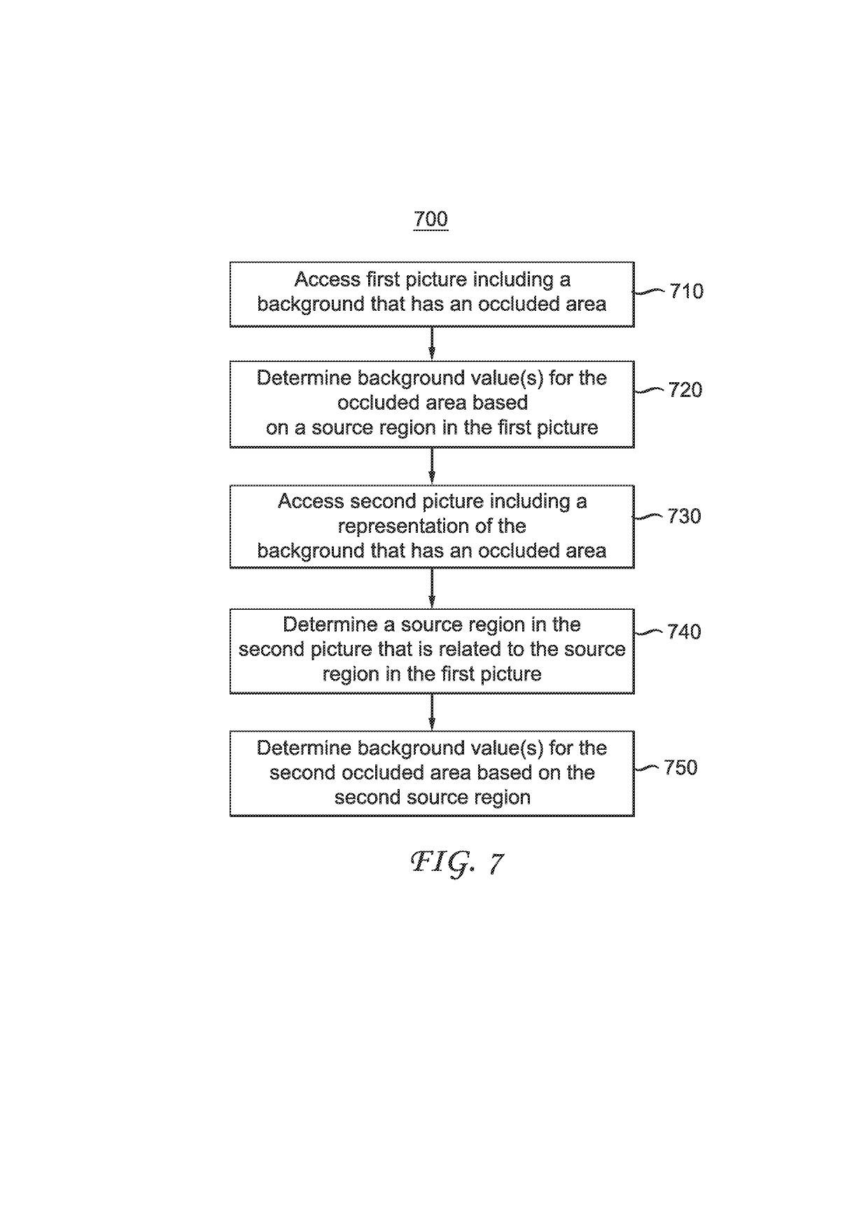

Referring to FIG. 7, there is shown a process 700 for determining background values. The process 700 includes accessing a first picture including a background that has an occluded area (710). In at least one implementation, the operation 710 includes accessing a first picture including a first representation of a background, the first representation of the background having an occluded area in the first picture. The operation 710 is performed, in various implementations, as described, for example, with respect to the input pictures block 210.

The process 700 includes determining one or more background values for the occluded area based on a source region in the first picture (720). In at least one implementation, the operation 720 includes determining a background value for one or more pixels in the occluded area in the first picture based on a source region in the first picture. The operation 720 is performed, in various implementations, as described, for example, with respect to the blocks 220, 230, 240, and 250 in the system 200.

The process 700 includes accessing a second picture including a representation of the background that has an occluded area (730). In at least one implementation, the operation 730 includes accessing a second picture including a second representation of the background, the second representation being different from the first representation and having an occluded area in the second picture. The operation 730 is performed, in various implementations, as described, for example, with respect to the input pictures block 210.

The process 700 includes determining a source region in the second picture that is related to the source region in the first picture (740). The operation 740 is performed, in various implementations, as described, for example, with respect to the blocks 250 and 255 in the system 200, and with respect to FIG. 6.

The process 700 includes determining one or more background values for the second occluded area based on the second source region (750). In at least one implementation, the operation 750 includes determining a background value for one or more pixels in the occluded area in the second picture using an algorithm that is based on the source region in the second picture. The operation 750 is performed, in various implementations, as described, for example, with respect to the blocks 220, 235, 245, and 255 in the system 200.

In at least one implementation, the operation 750 includes determining a background value for one or more pixels in the occluded area in the second picture using an algorithm that is based on the source region in the second picture. Such an algorithm is based on the source region by, for example, starting at the source region in the process of determining a good portion of the second picture to use in filling the fill portion. In such implementations, the fill portion is often filled with a portion from the second source that is not near the source region. However, the algorithm is still said to be based on the source region. Various such implementations restrict the algorithm to a specified neighborhood of the source region for determining a good portion to use in filling the fill portion.

In another implementation, the algorithm is based on the source region by, for example, using one or more of the values (or a function of the values) from the source region to fill the fill portion.

The first and second representations of the background in the process 700 are related in different ways in various implementations. For example, in various implementations, the first and second pictures are taken at different times, and/or the first and second pictures are taken from different views.

The process 700 states that the first and second pictures each have an occluded area. In various implementations, the two occluded areas are related to each other. For example, the two occluded areas are, in various implementations, co-located or corresponding. However, in other implementations, the two occluded areas are not related to each other.

In a professional 2D to 3D conversion setup, a human operator is typically involved in the hole filling process. A human operator can often analyze and understand the content, the structures, and the textures in the images better than computer software. Thus, the operator often has an idea of what the filling block should look like before it is filled. Accordingly, in various implementations, we provide a user interface to allow the operator to be involved in the hole filling process. These user interfaces provide flexibility to the inpainting process, and allow the results to vary based on an operator's input and decisions. In particular, according to various implementations, the operator is given the ability, for example: (i) to select which edges to continue, (ii) to select specific textures for different areas, (iii) to select the frames (for example, to select frames with similar content) that will be used to build a mosaic, (iv) to select the input frame set, (v) to select the reference frame for a given mosaic, (vi) to select the initial search neighborhood range S, (vii) to select the subsequent (co-located) search neighborhood range s, (viii) to divide the mosaic image for performing inpainting on the sub-divided portions, (ix) to select different sizes for a dividing of the mosaic image, and/or (x) to select various other settings for the inpainting process.

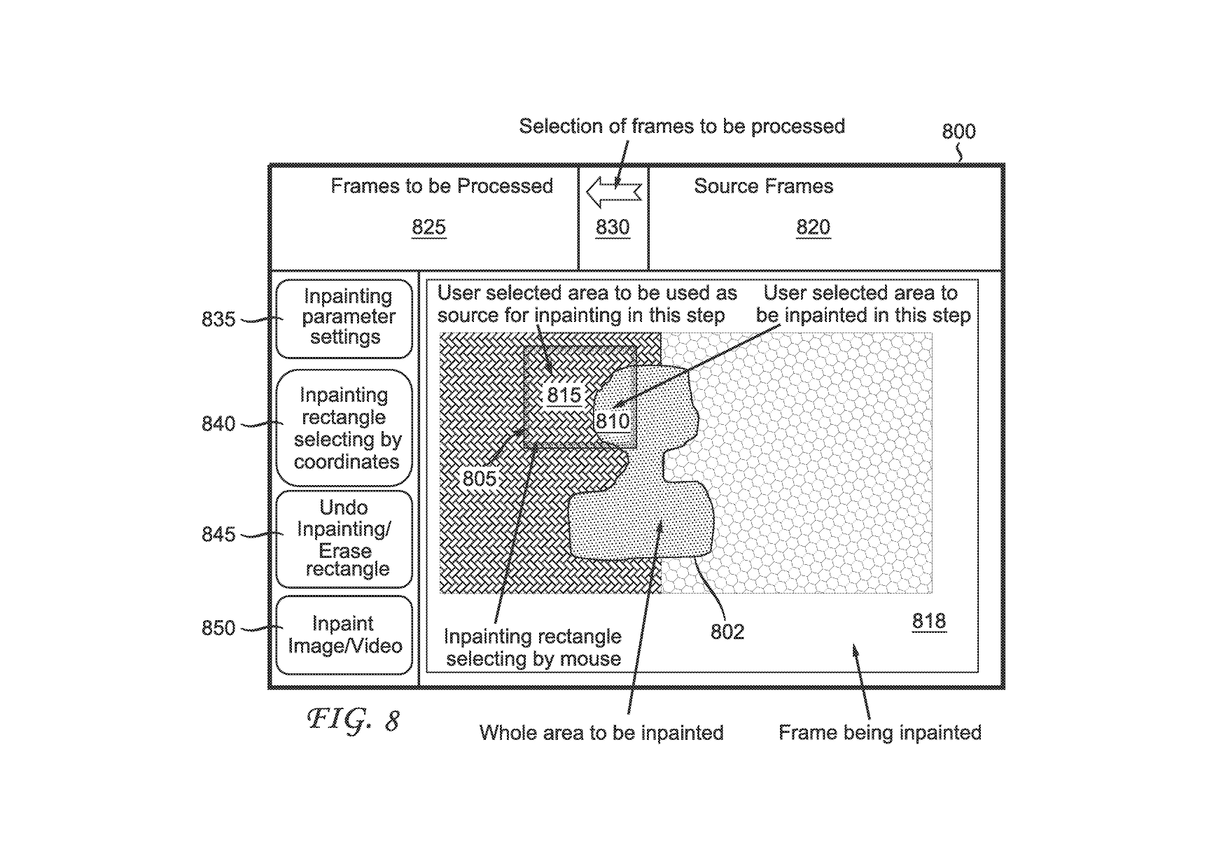

Referring to FIG. 8, a user interface 800 is provided to support various operator functions. The interface 800 allows, for example, a user or operator to try different settings to fill a region 802, and to save or to undo the operations and results. The region 802 is an occluded background region. The region 802 is represented in various implementations as, for example, a background hole, a foreground mask, or a foreground object. The interface 800 allows the operator to draw, or otherwise designate, an area 805 (shown as a rectangle) that contains a filling area 810, which is an unfilled area from the region 802 to be filled. The area 805 also contains a source area 815, which is the set of samples to be used to fill the filling area 810. The filling area 810 is filled using only samples from the selected source area 815, not the entire image. In this way, the operator can select an appropriate region in order to continue an edge, or the operator can use some other texture for a region. Because the operator often has more information about a scene than a computer program does, the operator's decisions and input can be expected to produce more convincing and perceptually logical fills.

The interface 800 also includes a display region 818 that displays all of part of a frame that is being processed. The interface 800 includes a listing or other display 820 of source frames, a listing or other display 825 of frames that are to be processed, and a select button 830 to select source frames to be processed. The interface 800 includes a selection button 835 to set various inpainting parameters, a selection button 840 to select the area 805 using coordinates rather than using a mouse, a selection button 845 to undo the inpainting and erase the rectangle that delineates the area 805. The button 845 would be selected, for example, if the operator determined that the inpainting was unsuccessful and that another area 805 was to be selected. The interface 800 includes a selection button 850 to perform the inpainting of one or more images. The button 850 would be selected, for example, to perform the inpainting process after a rectangle had been input to delineate the area 805. These inputs to the interface 800 are exemplary and are neither required nor exhaustive.

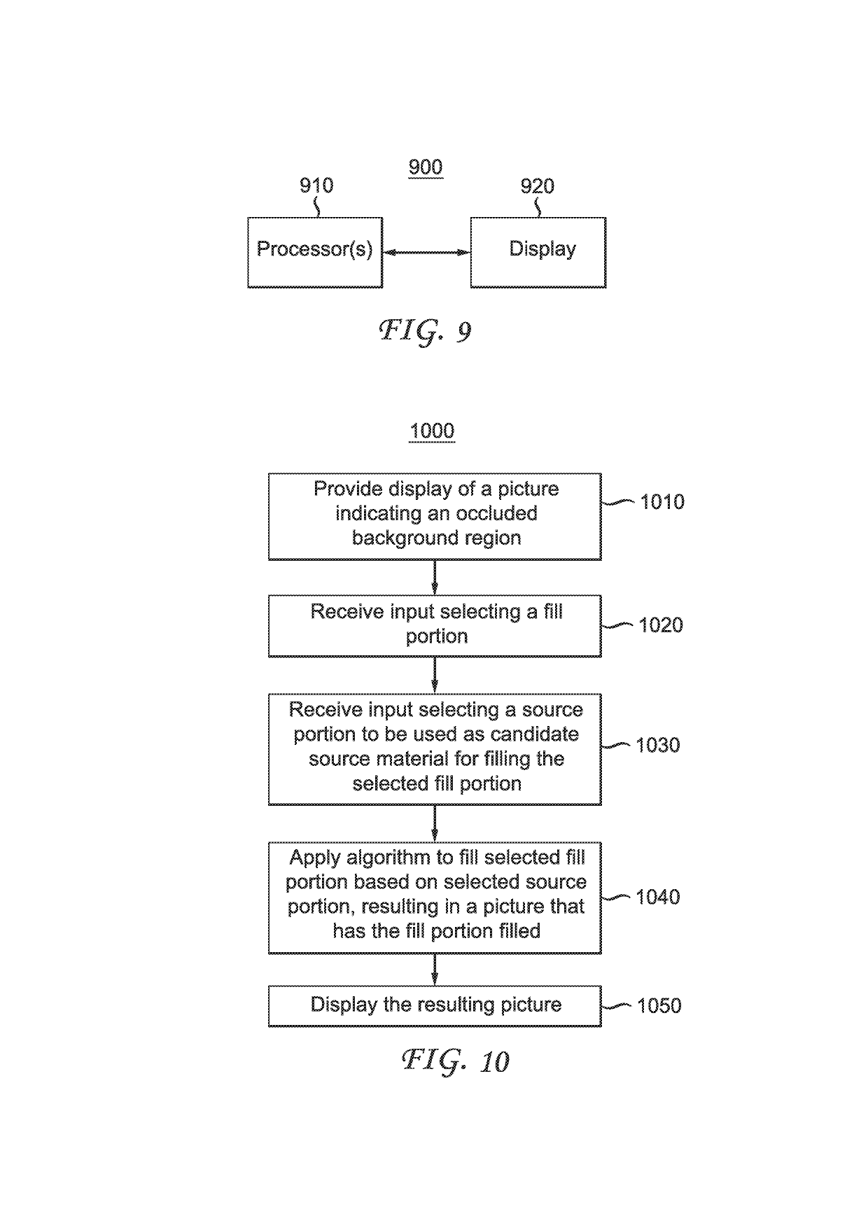

Referring to FIG. 9, a video editing device 900 is provided. The video editing device 900 includes one or more processors, collectively represented as processor(s) 910. The one or more processors 910 are, in various implementations, configured to collectively perform the operations of one or more of the inpainting processes described in this application. In one particular implementation, there is a single processor 910 programmed to perform the process 700. In another particular implementation, there is a plurality of processors collectively configured to perform the process associated with the system 200.

The video editing device 900 includes a display 920 that is communicatively coupled to at least one of the one or more processors 910. The display 910 is, in various implementations, for example, a screen of a computer, a laptop, or some other processing device. In one particular implementation, the display 920 is a display capable of displaying the interface 800, and the one or more processor(s) 910 are configured to provide the interface 800 on the display 920.

Referring to FIG. 10, a process 1000 is shown for inpainting. The process 1000 includes providing a display of a picture indicating an occluded background region (1010). The operation 1010 is performed, in various implementations, for example, by the interface 800 displaying the picture shown in FIG. 8.

The process 1000 includes receiving input selecting a fill portion of the occluded background region to be filled (1020). The operation 1020 is performed, in various implementations, for example, by the interface 800 accepting input from an operator designating the area 805 which effectively selects the filling area 810 as the portion to be filled. The area 805 can also be considered as a fill portion when, for example, the algorithm replaces the entire content of the area 805.

The process 1000 includes receiving input selecting a source portion of the picture to be used as candidate source material for filling the selected fill portion (1030). The operation 1030 is performed, in various implementations, for example, by the interface 800 accepting input from an operator designating the area 805 which effectively selects the source area 815 as the portion to be used as candidate source material for filling the selected fill portion. The area 805 can also be considered as a source portion when, for example, the algorithm uses previously-filled portions of the filling area 810 as part of the source material for filling remaining portions of the filling area 810.

The process 1000 includes applying an algorithm to fill the selected fill portion based on the selected source portion, resulting in a resulting picture that has the fill portion filled (1040). The operation 1040 is performed, in various implementations, for example, in response to an operator selecting the area 805, and then selecting the button 850 to apply an inpainting algorithm to the area 805. The algorithm that is implemented is, in various implementations, one of the methods described in this application, such as, for example, the process 700 or the process associated with the system 200.

The process 1000 includes displaying the resulting picture (1050). The operation 1050 is performed, in various implementations, for example, by the interface 800 displaying the inpainting results after accepting input from an operator selecting the area 805 and then selecting the button 850 to apply an inpainting algorithm to the area 805.

Note that various implementations do not perform the entire inpainting process for any given hole. Rather, if the application is directed to developing an alternate-eye view to create a stereoscopic picture pair, then the inpainting is only performed, in various implementations around the border of the hole. In this way, the inpainting is performed for pixels that will be revealed by a disparity shift of the foreground object, but the inpainting is not performed for pixels that would not be so revealed.

Another implementation actually provides more certainty by determining the hole areas that are to be filled. This implementation re-renders the foreground objects prior to hole filling by, for example, shifting the foreground objects by a designated disparity value. Further implementations, use the transformed and retransformed mask for the particular object(s), and apply the disparity shift to the retransformed mask. As explained in this application, the shifted foreground objects (retransformed, or not) are likely to overlay some of the previously remaining holes. Thus, those overlaid hole areas do not need to be inpainted, and this implementation reduces the then-remaining holes that are to be filled.

Another implementation applies one or more of the inpainting processes to non-background hole filling, and/or applies one or more of the inpainting processes iteratively to fill the background and/or non-background in different layers.

The processes 700 and 1000, and various implementations, use general terms such as, for example, occluded area, source region, occluded background region, fill portion, source portion, candidate source material, and candidate background source material. These terms refer, in general, to an area of an image that includes one or more pixels. Such areas may have any shape, and need not be contiguous.

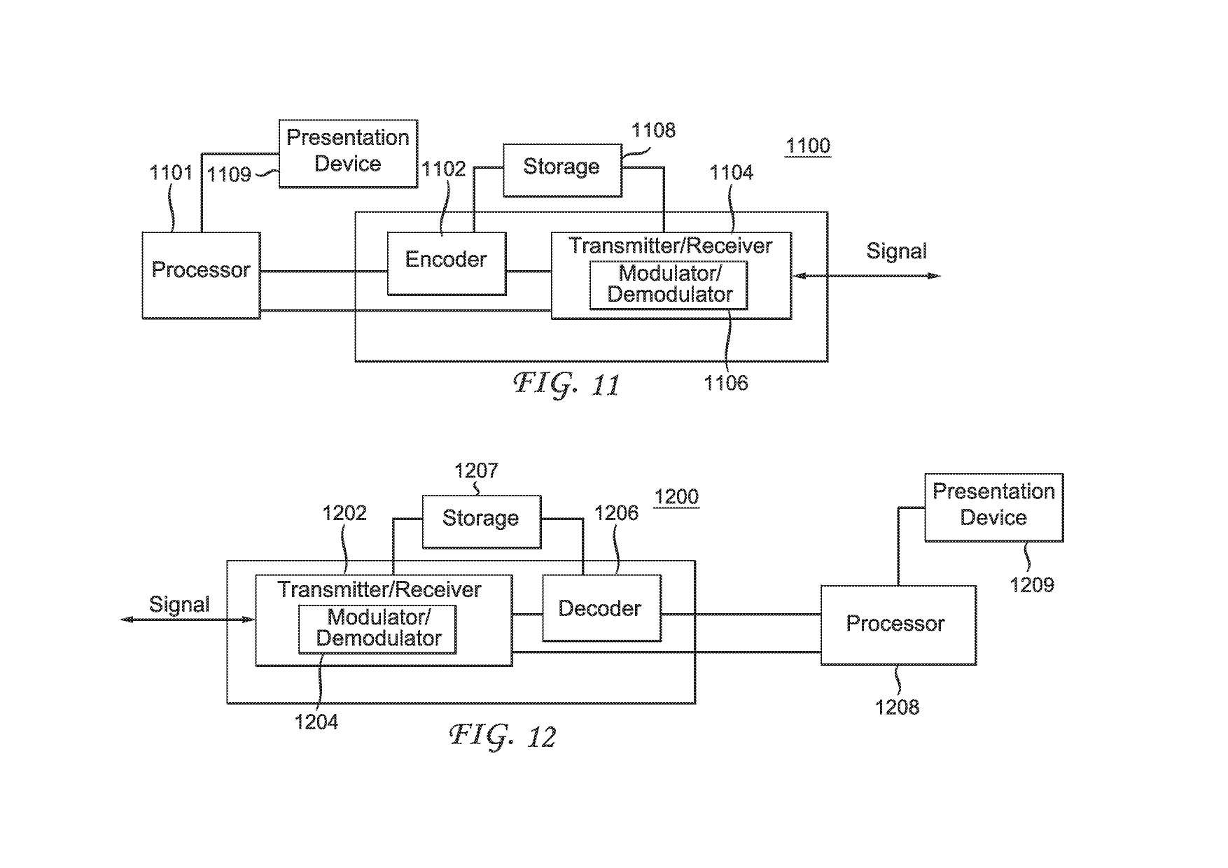

Referring to FIG. 11, a system or apparatus 1100 is shown, to which the features and principles described above may be applied. The system or apparatus 1100 may be, for example, a system for transmitting a signal using any of a variety of media, such as, for example, satellite, cable, telephone-line, terrestrial broadcast, infra-red, or radio frequency. The system or apparatus 1100 also, or alternatively, may be used, for example, to provide a signal for storage. The transmission may be provided, for example, over the Internet or some other network, or line of sight. The system or apparatus 1100 is capable of generating and delivering, for example, video content and other content, for use in, for example, providing a 3D video presentation. It should also be clear that the blocks of FIG. 11 provide a flow diagram of a process, in addition to providing a block diagram of a system or apparatus.

The system or apparatus 1100 receives an input video sequence from a processor 1101. In one implementation, the processor 1101 is part of the system or apparatus 1100. The input video sequence is, in various implementations, (i) an original input video sequence as described, for example, with respect to the input pictures block 210, (ii) an inpainted background video sequence as described, for example, with respect to the inpainted background sequence formation block 270, and/or (iii) a new view sequence as described, for example, with respect to the new view sequence formation block 280. Thus, the processor 1101 is configured, in various implementations, to perform one or more of the methods described in this application. In various implementations, the processor 1101 is configured for performing one or more of the process 700 or the process associated with the system 200.

The system or apparatus 1100 includes an encoder 1102 and a transmitter/receiver 1104 capable of transmitting the encoded signal. The encoder 1102 receives the display plane from the processor 1101. The encoder 1102 generates an encoded signal(s) based on the input signal and, in certain implementations, metadata information. The encoder 1102 may be, for example, an AVC encoder. The AVC encoder may be applied to both video and other information.

The encoder 1102 may include sub-modules, including for example an assembly unit for receiving and assembling various pieces of information into a structured format for storage or transmission. The various pieces of information may include, for example, coded or uncoded video, and coded or uncoded elements such as, for example, motion vectors, coding mode indicators, and syntax elements. In some implementations, the encoder 1102 includes the processor 1101 and therefore performs the operations of the processor 1101.

The transmitter/receiver 1104 receives the encoded signal(s) from the encoder 1102 and transmits the encoded signal(s) in one or more output signals. Typical transmitters perform functions such as, for example, one or more of providing error-correction coding, interleaving the data in the signal, randomizing the energy in the signal, and modulating the signal onto one or more carriers using a modulator/demodulator 1106. The transmitter/receiver 1104 may include, or interface with, an antenna (not shown). Further, implementations of the transmitter/receiver 1104 may be limited to the modulator/demodulator 1106.

The system or apparatus 1100 is also communicatively coupled to a storage unit 1108. In one implementation, the storage unit 1108 is coupled to the encoder 1102, and is the storage unit 1108 stores an encoded bitstream from the encoder 1102. In another implementation, the storage unit 1108 is coupled to the transmitter/receiver 1104, and stores a bitstream from the transmitter/receiver 1104. The bitstream from the transmitter/receiver 1104 may include, for example, one or more encoded bitstreams that have been further processed by the transmitter/receiver 1104. The storage unit 1108 is, in different implementations, one or more of a standard DVD, a Blu-Ray disc, a hard drive, or some other storage device.

The system or apparatus 1100 is also communicatively coupled to a presentation device 1109, such as, for example, a television, a computer, a laptop, a tablet, or a cell phone. Various implementations provide the presentation device 1109 and the processor 1101 in a single integrated unit, such as, for example, a tablet or a laptop. The processor 1101 provides an input to the presentation device 1109. The input includes, for example, a video sequence intended for processing with an inpainting algorithm. Thus, the presentation device 1109 is, in various implementations, the display 920. The input includes, as another example, a stereoscopic video sequence prepared using, in part, an inpainting process described in this application.

Referring now to FIG. 12, a system or apparatus 1200 is shown to which the features and principles described above may be applied. The system or apparatus 1200 may be configured to receive signals over a variety of media, such as, for example, satellite, cable, telephone-line, terrestrial broadcast, infrared, or radio frequency. The signals may be received, for example, over the Internet or some other network, or by line-of-sight. It should also be clear that the blocks of FIG. 12 provide a flow diagram of a process, in addition to providing a block diagram of a system or apparatus.

The system or apparatus 1200 may be, for example, a cell-phone, a computer, a tablet, a set-top box, a television, a gateway, a router, or other device that, for example, receives encoded video content and provides decoded video content for processing.

The system or apparatus 1200 is capable of receiving and processing content information, and the content information may include, for example, video images and/or metadata. The system or apparatus 1200 includes a transmitter/receiver 1202 for receiving an encoded signal, such as, for example, the signals described in the implementations of this application. The transmitter/receiver 1202 receives, in various implementations, for example, a signal providing one or more of a signal output from the system 1100 of FIG. 11, or a signal providing a transmission of a video sequence such as, for example, the video sequence described with respect to the input pictures block 210.

Typical receivers perform functions such as, for example, one or more of receiving a modulated and encoded data signal, demodulating the data signal from one or more carriers using a modulator/demodulator 1204, de-randomizing the energy in the signal, de-interleaving the data in the signal, and error-correction decoding the signal. The transmitter/receiver 1202 may include, or interface with, an antenna (not shown). Implementations of the transmitter/receiver 1202 may be limited to the modulator/demodulator 1204.

The system or apparatus 1200 includes a decoder 1206. The transmitter/receiver 1202 provides a received signal to the decoder 1206. The signal provided to the decoder 1206 by the transmitter/receiver 1202 may include one or more encoded bitstreams. The decoder 1206 outputs a decoded signal, such as, for example, a decoded display plane. The decoder 1206 is, in various implementations, for example, an AVC decoder.

The system or apparatus 1200 is also communicatively coupled to a storage unit 1207. In one implementation, the storage unit 1207 is coupled to the transmitter/receiver 1202, and the transmitter/receiver 1202 accesses a bitstream from the storage unit 1207. In another implementation, the storage unit 1207 is coupled to the decoder 1206, and the decoder 1206 accesses a bitstream from the storage unit 1207. The bitstream accessed from the storage unit 1207 includes, in different implementations, one or more encoded bitstreams. The storage unit 1207 is, in different implementations, one or more of a standard DVD, a Blu-Ray disc, a hard drive, or some other storage device.

The output video from the decoder 1206 is provided, in one implementation, to a processor 1208. The processor 1208 is, in one implementation, a processor configured for performing, for example, all or part of the process 700, or all or part of the process associated with the system 200. In another implementation, the processor 1208 is configured for performing one or more other post-processing operations.

In some implementations, the decoder 1206 includes the processor 1208 and therefore performs the operations of the processor 1208. In other implementations, the processor 1208 is part of a downstream device such as, for example, a set-top box, a tablet, a router, or a television. More generally, the processor 1208 and/or the system or apparatus 1200 are, in various implementations, part of a gateway, a router, a set-top box, a tablet, a television, or a computer.

The processor 1208 is also communicatively coupled to a presentation device 1209, such as, for example, a television, a computer, a laptop, a tablet, or a cell phone. Various implementations provide the presentation device 1209 and the processor 1208 in a single integrated unit, such as, for example, a tablet or a laptop. The processor 1208 provides an input to the presentation device 1209. The input includes, for example, a video sequence intended for processing with an inpainting algorithm. Thus, the presentation device 1209 is, in various implementations, the display 920. The input includes, as another example, a stereoscopic video sequence prepared using, in part, an inpainting process described in this application.

The system or apparatus 1200 is also configured to receive input from a user or other input source. The input is received, in typical implementations, by the processor 1208 using a mechanism not explicitly shown in FIG. 12. The input mechanism includes, in various implementations, a mouse or a microphone. In various implementations, however, the input is received through the presentation device 1209, such as, for example, when the presentation device is a touch screen. In at least one implementation, the input includes inpainting instructions as described, for example, with respect to FIGS. 8-10.

The system or apparatus 1200 is also configured to provide a signal that includes data, such as, for example, a video sequence to a remote device. The signal is, for example, modulated using the modulator/demodulator 1204 and transmitted using the transmitter/receiver 1202.

Referring again to FIG. 11, the system or apparatus 1100 is further configured to receive input, such as, for example, a video sequence. The input is received by the transmitter/receiver 1106, and provided to the processor 1101. In various implementations, the processor 1101 performs an inpainting process on the input.

Various implementations are described in this application that use a co-located block in another frame or mosaic, for example. In one such implementation, a co-located filling block in another mosaic is identified, and a co-located source block in that mosaic is used as a starting point for finding a good match. Alternate implementations use a corresponding block instead of a co-located block. For example, one implementation identifies a corresponding filling block and a corresponding source block in the other mosaic, and performs the search for a good match for the corresponding filling block by starting at the corresponding source block. In this way, the implementation is expected to accommodate more motion.

Referring again to FIG. 2, the operations performed by the system 200, including the operations performed by the blocks 220, 230, 235, 240, 245, 250, 255, 260, 265, 270, and 280, are, in various implementations, performed by a single processor. In other implementations, the operations are performed by multiple processors working in a collective manner to provide an output result.

It is noted that some implementations have particular advantages, or disadvantages. However, a discussion of the disadvantages of an implementation does not eliminate the advantages of that implementation, nor indicate that the implementation is not a viable and even recommended implementation.

Various implementations generate or process signals and/or signal structures. Such signals are formed, in certain implementations, using pseudo-code or syntax. Signals are produced, in various implementations, at the outputs of (i) the new sequence formation block 280, (ii) any of the processors 910, 1101, and 1208, (iii) the encoder 1102, (iv) any of the transmitter/receivers 1104 and 1202, or (v) the decoder 1206. The signal and/or the signal structure is transmitted and/or stored (for example, on a processor-readable medium) in various implementations.

This application provides multiple block/flow diagrams, including the block/flow diagrams of FIGS. 1-2, 7, and 9-12. It should be clear that the block/flow diagrams of this application present both a flow diagram describing a process, and a block diagram describing functional blocks of an apparatus, device, or system. Further, the block/flow diagrams illustrate relationships among the components and outputs of the components.

Additionally, this application provides multiple pictorial representations, including the pictorial representations of FIGS. 3-6 and 8. It should be clear that the pictorial representation of at least FIG. 8 presents both a visual representation of a device or screen, as well as a process for interacting with the device or screen, and the functional blocks of an associated device and system. Further, the pictorial representations of FIGS. 3-6 provide both a visual representation of a particular structures and data, as well as a process for interacting with the structures and data.

Additionally, many of the operations, blocks, inputs, or outputs of the implementations described in this application are optional, even if not explicitly stated in the descriptions and discussions of these implementations. For example, many of the operations discussed with respect to FIGS. 2 and 8 can be omitted in various implementations. The mere recitation of a feature in a particular implementation does not indicate that the feature is mandatory for all implementations. Indeed, the opposite conclusion should generally be the default, and all features are considered optional unless such a feature is stated to be required. Even if a feature is stated to be required, that requirement is intended to apply only to that specific implementation, and other implementations are assumed to be free from such a requirement.

We thus provide one or more implementations having particular features and aspects. In particular, we provide several implementations relating to inpainting holes in video pictures. Inpainting, as described in various implementations in this application, can be used in a variety of environments, including, for example, creating another view in a 2D-to-3D conversion process, and rendering additional views for 2D applications. Additional variations of these implementations and additional applications are contemplated and within our disclosure, and features and aspects of described implementations may be adapted for other implementations.

Several of the implementations and features described in this application may be used in the context of the AVC Standard, and/or AVC with the MVC extension (Annex H), and/or AVC with the SVC extension (Annex G). AVC refers to the existing International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (referred to in this application as the “H.264/MPEG-4 AVC Standard” or variations thereof, such as the “AVC standard”, the “H.264 standard”, “H.264/AVC”, or simply “AVC” or “H.264”). Additionally, these implementations and features may be used in the context of another standard (existing or future), or in a context that does not involve a standard.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, evaluating the information, predicting the information, or retrieving the information from memory.

Further, this application or its claims may refer to “accessing” various pieces of information. Accessing the information may include one or more of, for example, receiving the information, retrieving the information (for example, memory), storing the information, processing the information, transmitting the information, moving the information, copying the information, erasing the information, calculating the information, determining the information, predicting the information, evaluating the information, or estimating the information.

This application or its claims may refer to “providing” information from, for example, a first device (or location) to a second device (or location). This application or its claims may also, or alternatively, refer, for example, to “receiving” information from the second device (or location) at the first device (or location). Such “providing” or “receiving” is understood to include, at least, direct and indirect connections. Thus, intermediaries between the first and second devices (or locations) are contemplated and within the scope of the terms “providing” and “receiving”. For example, if the information is provided from the first location to an intermediary location, and then provided from the intermediary location to the second location, then the information has been provided from the first location to the second location. Similarly, if the information is received at an intermediary location from the first location, and then received at the second location from the intermediary location, then the information has been received from the first location at the second location.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

Various implementations refer to “images” and/or “pictures”. The terms “image” and “picture” are used interchangeably throughout this document, and are intended to be broad terms. An “image” or a “picture” may be, for example, all or part of a frame or of a field. The term “video” refers to a sequence of images (or pictures). An image, or a picture, may include, for example, any of various video components or their combinations. Such components, or their combinations, include, for example, luminance, chrominance, Y (of YUV or YCbCr or YPbPr), U (of YUV), V (of YUV), Cb (of YCbCr), Cr (of YCbCr), Pb (of YPbPr), Pr (of YPbPr), red (of RGB), green (of RGB), blue (of RGB), S-Video, and negatives or positives of any of these components. An “image” or a “picture” may also, or alternatively, refer to various different types of content, including, for example, typical two-dimensional video, a disparity map for a 2D video picture, a depth map that corresponds to a 2D video picture, or an edge map.

Further, many implementations may refer to a “frame”. However, such implementations are assumed to be equally applicable to a “picture” or “image”.

A “mask”, or similar terms, is also intended to be a broad term. A mask generally refers, for example, to a picture that includes a particular type of information. However, a mask may include other types of information not indicated by its name. For example, a background mask, or a foreground mask, typically includes information indicating whether pixels are part of the foreground and/or background. However, such a mask may also include other information, such as, for example, layer information if there are multiple foreground layers and/or background layers. Additionally, masks may provide the information in various formats, including, for example, bit flags and/or integer values.

Similarly, a “map” (for example, a “depth map”, a “disparity map”, or an “edge map”), or similar terms, are also intended to be broad terms. A map generally refers, for example, to a picture that includes a particular type of information. However, a map may include other types of information not indicated by its name. For example, a depth map typically includes depth information, but may also include other information such as, for example, video or edge information. Additionally, maps may provide the information in various formats, including, for example, bit flags and/or integer values.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C” and “at least one of A, B, or C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Additionally, many implementations may be implemented in one or more of an encoder (for example, the encoder 1102), a decoder (for example, the decoder 1206), a post-processor (for example, the processor 1208) processing output from a decoder, or a pre-processor (for example, the processor 1101) providing input to an encoder.

The processors discussed in this application do, in various implementations, include multiple processors (sub-processors) that are collectively configured to perform, for example, a process, a function, or an operation. For example, the processor 910, the processor 1101, and the processor 1208 are each, in various implementations, composed of multiple sub-processors that are collectively configured to perform the operations of the respective processors 910, 1101, and 1208. Further, other implementations are contemplated by this disclosure.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a set-top box, a gateway, a router, a microprocessor, an integrated circuit, or a programmable logic device. Processors also include communication devices, such as, for example, computers, cell phones, portable/personal digital assistants (“PDAs”), tablets, laptops, and other devices that facilitate communication of information between end-users. A processor may also include multiple processors that are collectively configured to perform, for example, a process, a function, or an operation. The collective configuration and performance may be achieved using any of a variety of techniques known in the art, such as, for example, use of dedicated sub-processors for particular tasks, or use of parallel processing.

Implementations of the various processes and features described herein may be embodied in a variety of different equipment or applications, particularly, for example, equipment or applications associated with inpainting, background estimation, rendering additional views, 2D-to-3D conversion, data encoding, data decoding, and other processing of images or other content. Examples of such equipment include a processor, an encoder, a decoder, a post-processor processing output from a decoder, a pre-processor providing input to an encoder, a video coder, a video decoder, a video codec, a web server, a set-top box, a laptop, a personal computer, a tablet, a router, a cell phone, a PDA, and other communication devices. As should be clear, the equipment may be mobile and even installed in a mobile vehicle.

Additionally, the methods may be implemented by instructions being performed by a processor (or by multiple processors collectively configured to perform such instructions), and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations.

For example, a signal may be formatted to carry as data the inpainted background sequence from the inpainted background sequence formation block 270 and/or the newly generated view from the new view sequence formation block 280, as discussed with respect to FIG. 2. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
accessing a first picture including a first representation of a background, the first representation of the background having an occluded area in the first picture;
determining a background value for one or more pixels in the occluded area in the first picture based on a source region in the first picture;
accessing a second picture including a second representation of the background, the second representation being different from the first representation and having an occluded area in the second picture;
determining a source region in the second picture that is related to the source region in the first picture; and
determining a background value for one or more pixels in the occluded area in the second picture using an algorithm that is based on the source region in the second picture.

2. The method of claim 1 wherein:
the first picture comprises a first mosaic formed by transforming one or more pictures from a sequence to a first common reference.

3. The method of claim 2 wherein:
content from the transformed sequence is included into the first mosaic in a first manner,
the second picture comprises a second mosaic that is also based on the transformed sequence from the first common reference, and
content from the transformed sequence is included into the second mosaic in a different manner than content from the transformed sequence is included into the first mosaic.

4. The method of claim 2 wherein:
the second picture comprises a second mosaic formed by transforming one or more pictures from the sequence to a second common reference, and the second common reference is different from the first common reference.

5. The method of claim 4 wherein:
the first common reference is from a first viewing angle, and the second common reference is from a second viewing angle that is different from the first viewing angle.

6. The method of claim 4 wherein:
the first common reference and the second common reference are both from a first viewing angle.

7. The method of claim 1 wherein the source region in the second picture is related to the source region in the first picture by being co-located with the source region in the first picture.

8. The method of claim 1 wherein the algorithm determines the background value for the one or more pixels in the occluded area in the second picture based on one or more pixels in a neighborhood of the source region in the second picture.

9. The method of claim 8 wherein:
the neighborhood is a strict subset of the second picture, and
determining the background value for the one or more pixels in the occluded area in the second picture comprises:
determining multiple candidate background values for the one or more pixels in the occluded area in the second picture based on the one or more pixels in the neighborhood; and
selecting a best of the multiple candidate background values as the background value for the one or more pixels in the occluded area in the second picture.

10. The method of claim 1 wherein the occluded area in the first picture is related to the occluded area in the second picture.

11. The method of claim 10 wherein the occluded area in the first picture is related to the occluded area in the second picture by being co-located with the occluded in the area in the second picture.

12. The method of claim 10 further comprising:
determining a background value for one or more pixels in a second occluded area in the first picture;
determining a background value for one or more pixels in a second occluded area in the second picture, the second occluded area in the first picture being related to the second occluded area in the second picture, and
wherein the background values for the occluded areas in the second picture are determined in a same order as the background values are determined for the related occluded areas in the first picture.

13. The method of claim 1 wherein:
determining the background value for the one or more pixels in the occluded area in the second picture comprises setting the background value for the one or more pixels in the occluded area in the second picture equal to a value of a pixel in the source region in the second picture.

14. The method of claim 1 further comprising:
creating a background version of the first picture that includes the determined background value for the one or more pixels in the occluded area in the first picture.

15. The method of claim 14 wherein the first picture includes a foreground object at a particular position within the first picture, and the method further comprises:
creating an additional view from the first picture, wherein creating the additional view comprises adding the foreground object from the first picture into the background version of the first picture at a position different from the particular position using a disparity offset.

16. The method of claim 15 further comprising:
providing the first picture and the additional view as a stereoscopic picture pair that conveys three-dimensional information.

17. The method of claim 1 wherein the one or more pixels in the occluded area in the second picture are co-located with the one or more pixels in the occluded area in the first picture.

18. The method of claim 1 wherein the first representation differs from the second representation in one or more of the following ways:
the first representation and the second representation are from different times,
the first representation and the second representation are from different views,
the first representation and the second representation are from different positions,
the first representation and the second representation have different colors,
the first representation and the second representation have different sizes,
the first representation and the second representation have different zooms, or
the first representation and the second representation have different light intensities.

19. An apparatus comprising:
means for accessing a first picture including a first representation of a background, the first representation of the background having an occluded area in the first picture;
means for determining a background value for one or more pixels in the occluded area in the first picture based on a source region in the first picture;
means for accessing a second picture including a second representation of the background, the second representation being different from the first representation and having an occluded area in the second picture;
means for determining a source region in the second picture that is related to the source region in the first picture; and
means for determining a background value for one or more pixels in the occluded area in the second picture using an algorithm that is based on the source region in the second picture.

20. An apparatus comprising one or more processors collectively configured to perform at least the following:
accessing a first picture including a first representation of a background, the first representation of the background having an occluded area in the first picture;
determining a background value for one or more pixels in the occluded area in the first picture based on a source region in the first picture;
accessing a second picture including a second representation of the background, the second representation being different from the first representation and having an occluded area in the second picture;
determining a source region in the second picture that is related to the source region in the first picture; and
determining a background value for one or more pixels in the occluded area in the second picture using an algorithm that is based on the source region in the second picture.

21. The apparatus of claim 20 wherein the apparatus comprises one or more of an encoder, a decoder, a modulator, a demodulator, a receiver, a set-top box, a gateway, a router, a tablet, a remote control, or a laptop.

22. A processor readable medium having stored thereon instructions for causing one or more devices to collectively perform at least the following:
accessing a first picture including a first representation of a background, the first representation of the background having an occluded area in the first picture;
determining a background value for one or more pixels in the occluded area in the first picture based on a source region in the first picture;
accessing a second picture including a second representation of the background, the second representation being different from the first representation and having an occluded area in the second picture;
determining a source region in the second picture that is related to the source region in the first picture; and
determining a background value for one or more pixels in the occluded area in the second picture using an algorithm that is based on the source region in the second picture.

23. A method comprising providing a display of a picture that indicates an occluded background region;
receiving input selecting a fill portion of the occluded background region to be filled;
receiving input selecting a source portion of the picture to be used as candidate background source material for filling the selected fill portion;
applying an algorithm to fill the selected fill portion based on the selected source portion, resulting in a resulting picture that has the fill portion filled; and
displaying the resulting picture.

24. The method of claim 23 further comprising:
receiving input, after displaying the resulting picture, selecting a different source portion of the picture to be used as candidate source material for filling the selected fill portion;
applying the algorithm to fill the fill portion based on the different source portion, resulting in a different resulting picture that has the fill portion filled; and
displaying the different resulting picture.

25. The method of claim 23 wherein applying the algorithm comprises performing the methods of one or more of the method claims 1-18.

26. The method of claim 23 wherein:
the input selecting the fill portion and the input selecting the source portion are provided in a single input that identifies a particular region of the picture that partially overlaps the occluded background region, and
the particular region includes the fill portion as a portion of the particular region that overlaps the occluded background region, and the particular region includes the source portion as a portion of the particular region that does not overlap the occluded background region.

27. The method of claim 23 wherein applying the algorithm comprises filling the fill portion with a particular area of the source portion, and the method further comprises:
identifying a related fill portion in a second picture, the related fill portion being related to the fill portion in the picture;
identifying a related source portion in the second picture, the related source portion being related to the particular area of the source portion in the picture; and
applying an algorithm to fill the related fill portion based on the related source portion.

28. The method of claim 27 wherein the algorithm fills the related fill portion based on one or more pixels in a neighborhood determined by the related source portion.

29. The method of claim 23 wherein the picture indicates the occluded background region by including a mask for a foreground object.

30. An apparatus comprising:
means for providing a display of a picture that indicates an occluded background region;
means for receiving input selecting a fill portion of the occluded background region to be filled;
means for receiving input selecting a source portion of the picture to be used as candidate background source material for filling the selected fill portion;
means for applying an algorithm to fill the selected fill portion based on the selected source portion, resulting in a resulting picture that has the fill portion filled; and
means for displaying the resulting picture.

31. An apparatus comprising one or more processors collectively configured to perform at least the following:
providing a display of a picture that indicates an occluded background region;
receiving input selecting a fill portion of the occluded background region to be filled;
receiving input selecting a source portion of the picture to be used as candidate background source material for filling the selected fill portion;
applying an algorithm to fill the selected fill portion based on the selected source portion, resulting in a resulting picture that has the fill portion filled; and
displaying the resulting picture.

32. The apparatus of claim 31 wherein the apparatus comprises one or more of an encoder, a decoder, a modulator, a demodulator, a receiver, a set-top box, a gateway, a router, a tablet, a remote control, or a laptop.

33. A processor readable medium having stored thereon instructions for causing one or more devices to collectively perform at least the following:
providing a display of a picture that indicates an occluded background region;
receiving input selecting a fill portion of the occluded background region to be filled;
receiving input selecting a source portion of the picture to be used as candidate background source material for filling the selected fill portion;
applying an algorithm to fill the selected fill portion based on the selected source portion, resulting in a resulting picture that has the fill portion filled; and
displaying the resulting picture.
